(19) United States
(12) Patent Application Publication
(10) Pub. No.: US 2026/0206067 A1
(43) Pub. Date: Jul. 16, 2026

(54) METHODS AND APPARATUSES FOR PRACH REPETITION

(71) Applicant: LENOVO (BEIJING) LIMITED, Beijing (CN)

(72) Inventors: Yuantao ZHANG, Beijing (CN); Ruixiang MA, Beijing (CN); Hongmei LIU, Beijing (CN); Zhi YAN, Beijing (CN); Haiming WANG, Beijing (CN)

(21) Appl. No.: 19/137,154

(22) PCT Filed: Dec. 16, 2022
(86) PCT No.: PCT/CN2022/139758

§ 371 Date: Jun. 9, 2025

(51) Int. Cl. H04W 74/0833; H04W 72/0453; H04W 74/08

(52) U.S. Cl. CPC H04W 74/0833; H04W 72/0453; H04W 74/0875

(57) ABSTRACT

Embodiments of the present disclosure relate to methods and apparatuses for physical random access channel (PRACH) repetition. According to an embodiment of the present disclosure, a user equipment (UE) can include: a transceiver; and a processor coupled to the transceiver, the processor configured to cause the UE to: receive configuration information indicating at least one synchronization signal and physical broadcast channel (PBCH) block (SSB); receive configuration information configuring a plurality of random access channel (RACH) occasions (ROs); and associate a group of SSBs, including one or more SSBs, of the at least one SSB to a set of ROs of the plurality of ROs according to an association configuration and based at least in part on a PRACH repetition number.

### TECHNICAL FIELD

Embodiments of the present application generally relate to wireless communication technologies, and especially to methods and apparatuses for physical random access channel (PRACH) repetition.

### BACKGROUND

In new radio (NR) systems, a random access procedure may be utilized for various purposes. For example, it may be utilized by a user equipment (UE) in initial access to find a cell to camp on; or it may be utilized by a UE which is in a radio resource control (RRC) IDLE state or RRC_INACTIVE state to switch to an RRC_CONNECTED state to start data transmission or reception; or it may be utilized by a UE in an RRC_CONNECTED state to re-establish the lost uplink (UL) synchronization, etc.

The UE may start a random access procedure by transmitting a preamble in a PRACH. In some cases, the PRACH may be a bottlenecked channel which has the worst coverage performance. Given this, how to improve the coverage of the PRACH needs to be addressed.

### SUMMARY OF THE APPLICATION

Embodiments of the present application at least provide technical solutions for PRACH repetition.

According to some embodiments of the present application, a UE may include: a transceiver; and a processor coupled to the transceiver, the processor configured to cause the UE to: receive configuration information indicating at least one synchronization signal and physical broadcast channel (PBCH) block (SSB); receive configuration information configuring a plurality of random access channel (RACH) occasions (ROs); and associate a group of SSBs, including one or more SSBs, of the at least one SSB to a set of ROs of the plurality of ROs according to an association configuration and based at least in part on a PRACH repetition number.

In some embodiments of the present application, the processor is further configured to cause the UE to: determine an SSB from the at least one SSB for transmitting PRACH repetitions, wherein the group of SSBs includes the determined SSB; determine one or more ROs associated with the determined SSB for transmitting the PRACH repetitions; and transmit the PRACH repetitions in the determined one or more ROs.

In some embodiments of the present application, the processor is further configured to cause the UE to: determine the PRACH repetition number from at least one PRACH repetition number, wherein the at least one PRACH repetition number is configured by configuration information; or receive configuration information indicating the PRACH repetition number; or wherein the PRACH repetition number is pre-defined for the UE.

In some embodiments of the present application, the plurality of ROs are separately configured for PRACH repetition.

In some embodiments of the present application, an SSB of the group of SSBs is associated with a set of time consecutive ROs.

In some embodiments of the present application, the processor is further configured to cause the UE to: receive configuration information indicating the number of frequency domain multiplexed (FDMed) ROs in a frequency domain; and divide the at least one SSB into at least one group of SSBs, wherein the number of groups of SSBs is equal to the number of FDMed ROs.

In some embodiments of the present application, in the case that the number of FDMed ROs is equal to 1, the group of SSBs consists of the at least one SSB.

In some embodiments of the present application, all of the at least one group of SSBs contain the same number of consecutive SSBs; a group of SSBs with an index i includes SSBs with indexes i+n*K in the at least one SSB, wherein 0≤i≤K−1, n=0, 1, 2 . . . N, K is the number of groups of SSBs, and i+N*K is less than or equal to a maximum index of the at least one SSB; a group of SSBs of the at least one group of SSBs includes SSB(s) associated with the same PRACH repetition number; a group of SSBs of the at least one group of SSBs includes SSB(s) mapped to RO(s) locating in the same frequency domain position; or SSB(s) in each group of SSBs of the at least one group of SSBs is(are) configured by a base station (BS).

In some embodiments of the present application, SSB(s) in the group of SSBs is(are) associated to a set of ROs locating in the same frequency domain position.

In some embodiments of the present application, in the case that the number of time consecutive ROs associated with an SSB determined based on the association configuration is equal to or larger than the PRACH repetition number, the group of SSBs is associated to the set of ROs by following a first association mechanism; or in the case that the number of time consecutive ROs associated with an SSB determined based on the association configuration is less than the PRACH repetition number, the group of SSBs is associated to a set of ROs by following a second association mechanism.

In some embodiments of the present application, the processor is further configured to cause the UE to divide the plurality of ROs into at least one RO group, the number of RO groups in the at least one RO group is equal to the number of groups of SSBs, each RO group includes a corresponding set of ROs locating in the same frequency domain position, and a group of SSBs of the at least one group of SSBs is associated to a corresponding RO group of the at least one RO group.

In some embodiments of the present application, the first association mechanism includes that the group of SSBs is associated to the set of ROs in an increasing order of time resource indexes of ROs.

In some embodiments of the present application, the second association mechanism includes that: the group of SSBs is associated to the set of ROs in an increasing order of time resource indexes of ROs; and for each RO, an association between SSB(s) and the RO is extended to N ROs, wherein N is a positive integer.

In some embodiments of the present application, in the case that the number of SSBs associated with an RO determined based on the association configuration is larger than or equal to 1, N is equal to the PRACH repetition number; or in the case that the number of SSBs associated with an RO determined based on the association configuration is less than 1, N is equal to the PRACH repetition number multiplied by the number of SSBs associated with an RO.

In some embodiments of the present application, the processor is further configured to cause the UE to: determine an SSB to RO association period for the group of SSBs, wherein the SSB to RO association period is X times of a PRACH configuration period, and includes at least one mapping cycle for SSB(s) in the group of SSBs, wherein X is a positive integer.

In some embodiments of the present application, the SSB to RO association period includes at least one mapping cycle for SSB(s) in a group of SSBs which includes the largest number of SSBs among the at least one group of SSBs.

According to some embodiments of the present application, a BS may include: a transceiver; and a processor coupled to the transceiver, the processor configured to cause the BS to: transmit configuration information indicating at least one SSB; transmit configuration information configuring a plurality of ROs; and associate a group of SSBs, including one or more SSBs, of the at least one SSB to a set of ROs of the plurality of ROs according to an association configuration and based at least in part on a PRACH repetition number.

In some embodiments of the present application, the processor is further configured to cause the BS to transmit configuration information indicating the PRACH repetition number; or the PRACH repetition number is pre-defined.

In some embodiments of the present application, the plurality of ROs are separately configured for PRACH repetition.

In some embodiments of the present application, an SSB of the group of SSBs is associated with a set of time consecutive ROs.

In some embodiments of the present application, the processor is further configured to cause the BS to: transmit configuration information indicating the number of FDMed ROs in a frequency domain; and divide the at least one SSB into at least one group of SSBs, wherein the number of groups of SSBs is equal to the number of FDMed ROs.

In some embodiments of the present application, in the case that the number of FDMed ROs is equal to 1, the group of SSBs consists of the at least one SSB.

In some embodiments of the present application, all of the at least one group of SSBs contain the same number of consecutive SSBs; a group of SSBs with an index i includes SSBs with indexes i+n*K in the at least one SSB, wherein 0≤i≤K−1, n=0, 1, 2 . . . N, K is the number of groups of SSBs, and i+N*K is less than or equal to a maximum index of the at least one SSB; a group of SSBs of the at least one group of SSBs includes SSB(s) associated with the same PRACH repetition number; a group of SSBs of the at least one group of SSBs includes SSB(s) mapped to RO(s) locating in the same frequency domain position; or SSB(s) in each group of SSBs of the at least one group of SSBs is(are) configured by the BS.

In some embodiments of the present application, SSB(s) in the group of SSBs is(are) associated to a set of ROs locating in the same frequency domain position.

In some embodiments of the present application, in the case that the number of time consecutive ROs associated with an SSB determined based on the association configuration is equal to or larger than the PRACH repetition number, the group of SSBs is associated to the set of ROs by following a first association mechanism; or in the case that the number of time consecutive ROs associated with an SSB determined based on the association configuration is less than the PRACH repetition number, the group of SSBs is associated to the set of ROs by following a second association mechanism.

In some embodiments of the present application, the processor is further configured to cause the BS to divide the plurality of ROs into at least one RO group, the number of RO groups in the at least one RO group is equal to the number of groups of SSBs, each RO group includes a corresponding set of ROs locating in the same frequency domain position, and a group of SSBs of the at least one group of SSBs is associated to a corresponding RO group of the at least one RO group.

In some embodiments of the present application, the first association mechanism includes that the group of SSBs is associated to the set of ROs in an increasing order of time resource indexes of ROs.

In some embodiments of the present application, the second association mechanism includes that: the group of SSBs is associated to the set of ROs in an increasing order of time resource indexes of ROs; and for each RO, an association between SSB(s) and the RO is extended to N ROs, wherein N is a positive integer.

In some embodiments of the present application, in the case that the number of SSBs associated with an RO determined based on the association configuration is larger than or equal to 1, N is equal to the PRACH repetition number; or in the case that the number of SSBs associated with an RO determined based on the association configuration is less than 1, N is equal to the PRACH repetition number multiplied by the number of SSBs associated with an RO.

In some embodiments of the present application, the processor is further configured to cause the BS to: determine an SSB to RO association period for the group of SSBs, wherein the SSB to RO association period is X times of a PRACH configuration period, and includes at least one mapping cycle for SSB(s) in the group of SSBs, wherein X is a positive integer.

In some embodiments of the present application, the SSB to RO association period includes at least one mapping cycle for SSB(s) in a group of SSBs which includes the largest number of SSBs among the at least one group of SSBs.

According to some embodiments of the present application, a method performed by a UE may include: receiving configuration information indicating at least one SSB; receiving configuration information configuring a plurality of ROs; and associating a group of SSBs, including one or more SSBs, of the at least one SSB to a set of ROs of the plurality of ROs according to an association configuration and based at least in part on a PRACH repetition number.

According to some embodiments of the present application, a method performed by a BS may include: transmitting configuration information indicating at least one SSB; transmitting configuration information configuring a plurality of ROs; and associating a group of SSBs, including one or more SSBs, of the at least one SSB to a set of ROs of the plurality of ROs according to an association configuration and based at least in part on a PRACH repetition number.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary random access procedure according to some embodiments of the present application;

FIG. 3 illustrates an exemplary RACH resource structure within a PRACH configuration period according to some embodiments of the present application;

FIGS. 4A-4C illustrate three exemplary associations between SSBs and ROs according to some embodiments of the present application;

FIG. 5 is a flow chart illustrating an exemplary method for PRACH repetition according to some embodiments of the present application;

FIGS. 6A and 6B illustrate two exemplary associations between SSBs and ROs according to some embodiments of the present application;

FIGS. 7A-7C illustrate three exemplary associations between SSBs and ROs according to some embodiments of the present application;

FIGS. 8A and 8B illustrate two exemplary associations between SSBs and ROs according to some embodiments of the present application;

FIG. 9 illustrates an exemplary method for determining an SSB to RO association period according to some embodiments of the present application;

FIG. 10 is a flow chart illustrating another exemplary method for PRACH repetition according to some embodiments of the present application; and

FIG. 11 illustrates a simplified block diagram of an exemplary apparatus for PRACH repetition according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

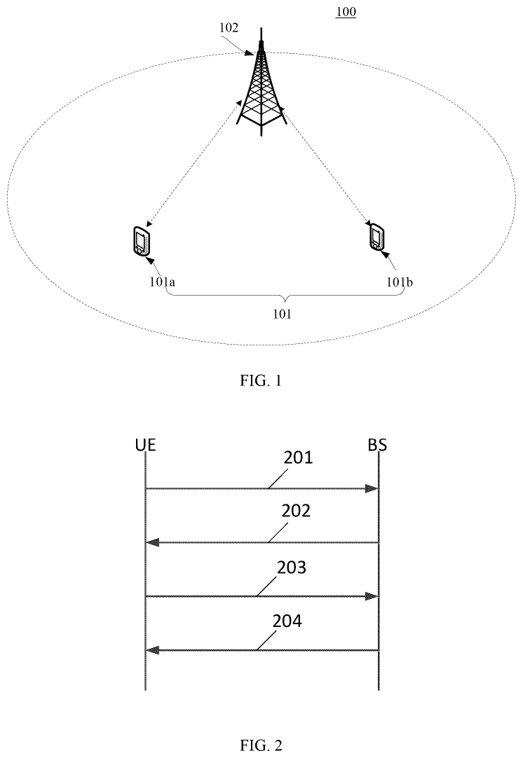

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

Both the UE 101a and the UE 101b in the embodiments of FIG. 1 are in a coverage area of the BS 102, and may transmit information or data to the BS 102 and receive control information or data from the BS 102, for example, via LTE or NR Uu interface. In other embodiments, one or more of the UE 101a and the UE 101b may be outside of the coverage area of the BS 102. In some embodiments, the UE 101a and the UE 101b may communicate with each other via sidelink.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. The BS 102 is generally a part of a radio access network that may include one or more controllers communicably coupled to the BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein the BS(s) 102 transmit data using an orthogonal frequency division multiplexing (OFDM) modulation scheme on the downlink (DL) and the UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS(s) 102 may communicate using other communication protocols, such as the IEEE 802.11 family of wireless communication protocols. Further, in some embodiments of the present disclosure, the BS(s) 102 may communicate over licensed spectrums, whereas in other embodiments, the BS(s) 102 may communicate over unlicensed spectrums. The present disclosure is not intended to be limited to the implementation of any particular wireless communication system architecture or protocol. In yet some embodiments of the present disclosure, the BS(s) 102 may communicate with the UE(s) 101 using the 3GPP 5G protocols.

In NR systems, a random access procedure may be utilized for various purposes. For example, it may be utilized by a UE in initial access to find a cell to camp on; or it may be utilized by a UE which is in an RRC IDLE state or RRC_INACTIVE state to switch to an RRC_CONNECTED state to start data transmission or reception; or it may be utilized by a UE in an RRC_CONNECTED state to re-establish the lost UL synchronization, etc.

FIG. 2 illustrates an exemplary random access procedure according to some embodiments of the present application. In the embodiments of FIG. 2, the random access procedure may be a 4-step RACH procedure which includes steps 201-204.

Referring to FIG. 2, in step 201, a UE may transmit Msg1 in a RACH occasion (RO) to a BS. The Msg1 may include a preamble (e.g., PRACH preamble) selected by the UE.

After receiving the Msg1, in step 202, the BS may transmit a random access response (RAR) in Msg2 to the UE. The RAR may be scheduled by downlink control information (DCI). The DCI may be identified (e.g., scrambled) by a random access radio network temporary identity (RA-RNTI) which is determined by at least one of the time position or frequency position of the RO in which the preamble is transmitted. That is, for different ROs, the corresponding RA-RNTIs may be different. The RAR may indicate reception of the preamble and provide necessary information for the UE to transmit Msg3. For example, the RAR may include a timing advance (TA) command, UL grant for transmitting Msg3, etc.

Consequently, in step 202, the UE may receive the RAR from the BS. Specifically, the UE may start an RAR window after a time gap relative to the transmission of Msg1. Within the RAR window, the UE may monitor DCI for scheduling the RAR and receives the RAR.

After receiving the RAR, in step 203, the UE may transmit Msg3 to the BS. The Msg3 may include an identity of the UE. After receiving the Msg3, in step 204, the BS may transmit Msg4 to the UE. The Msg4 may include the same identity of the UE included in Msg3 to indicate the success of the random access procedure of the UE. In other words, the Msg3 and Msg4 are used to solve potential collisions due to simultaneous transmissions of the same preamble from different UEs.

According to some embodiments of the present application, the BS may configure a plurality of ROs for transmitting the preamble, and the RO in which the preamble is transmitted in step 201 may be determined from the plurality of ROs. Each RO of the plurality of ROs may occupy multiple consecutive resource blocks (RBs) in the frequency domain. In the time domain, the ROs may be configured in every PRACH configuration period, which contains a set of radio frames. Within a PRACH configuration period, a subset of subframes may be indicated to contain a set of PRACH slots. Within each PRACH slot of the set of PRACH slots, there may be a set of ROs available for transmitting Msg1 as stated above. In the frequency domain, the BS may configure FDMed ROs. For example, the configuration information msg1-FDM may indicate a number of FDMed ROs in the frequency domain.

In some embodiments, the UE needs to determine valid ROs among the ROs configured in the time domain and frequency domain. For example, for time division duplexing (TDD), an RO in a PRACH slot is considered valid if it is within UL symbols configured by a cell common configuration (e.g., tdd-UL-DL-ConfigCommon as specified in 3GPP standard documents), or if it doesn't overlap or precede a DL symbol configured by the cell common configuration (e.g., tdd-UL-DL-ConfigCommon as specified in 3GPP standard documents) or an SSB in a slot, and is at least a gap (e.g., the gap>=0 symbols) after the last DL symbol or SSB.

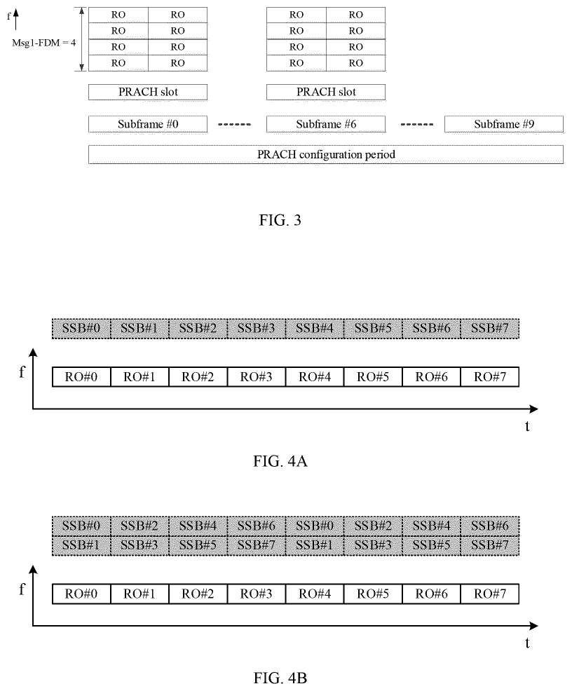

FIG. 3 illustrates an exemplary RACH resource structure within a PRACH configuration period according to some embodiments of the present application.

In the example of FIG. 3, the PRACH configuration period may include 10 subframes indexed as subframes #0 to #9, wherein subframe #0 and subframe #6 are configured to contain PRACH slots. Moreover, it is assumed that the time duration of a PRACH slot is the same as that of a subframe. A PRACH slot is configured with 2 ROs in the time domain and 4 ROs in the frequency domain (e.g., msg1-FDM =4).

The RACH resource structure in FIG. 3 is only for illustrative purposes, and it is contemplated that a RACH resource within a PRACH configuration period may have other structures according to other parameters configured by the BS.

A valid RO may be associated with one or more synchronization signal and PBCH blocks (SSBs). An SSB may be associated with a beam in the spatial domain. An SSB may include a primary synchronization signal (PSS), a secondary synchronization signal (SSS), and PBCH, and may be used for the UE to synchronize to the downlink (DL), obtain the cell ID, acquire system information, etc.

In some embodiments of the present application, the BS may configure a plurality of SSBs for UEs, e.g., the indexes of a plurality of SSBs may be included in the system information from the BS. In such embodiments, the UE may obtain configuration information indicating the plurality of SSBs (e.g., the UE may obtain the indexes of the plurality of SSBs in the system information). Then, the UE may measure the channel status of each SSB of the plurality of SSBs, select one SSB with good channel quality, and transmit the preamble in an RO which is associated with the selected SSB.

In some embodiments of the present application, the association between SSBs and ROs may be configured by the BS to the UE. Specifically, the BS may transmit configuration information to the UE to indicate the association between SSBs and ROs, for example, the BS may transmit configuration information SSB-PerRACH-OccasionAndCB-PreamblesPerSSB to indicate the association between SSBs and ROs. This configuration information may include two parameters, i.e., SSB-PerRACH-Occaison indicating a number of SSB indexes associated with one RO and CB-PreamblesPerSSB indicating a number of preambles per SSB index per RO. In an embodiment, the configuration information (e.g., SSB-PerRACH-Occasion=1) may indicate that one SSB is associated with one RO (referred to as 1-to-1 association hereinafter). In another embodiment, the configuration information (e.g., SSB-PerRACH-Occasion=N, where N is a positive integer larger than 1) may indicate that N SSBs is associated with one RO (referred to as N-to-1 association hereinafter). In yet another example, the configuration information (e.g., SSB-PerRACH-Occasion=1/N, where N is a positive integer larger than 1) may indicate that one SSB is associated with N consecutive ROs (referred to as 1-to-N association hereinafter).

The association between SSBs and ROs may be performed periodically in each SSB to RO association period. The SSB to RO association period may be X (which is a positive integer) times of a PRACH configuration period and contain one or multiple SSB-to-RO mapping cycles. The duration of the SSB to RO association period is the minimum period such that within the SSB to RO association period, each SSB is associated with at least one RO.

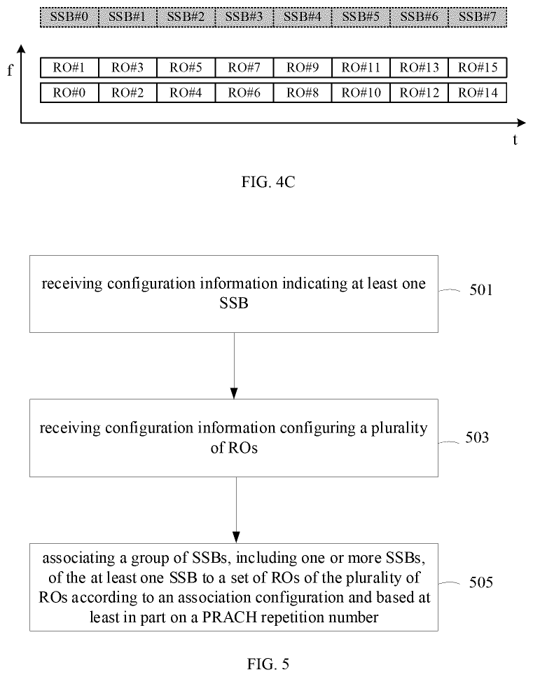

FIGS. 4A-4C illustrate three exemplary associations between SSBs and ROs according to some embodiments of the present application.

FIG. 4A shows a 1-to-1 association between SSBs and ROs (e.g., SSB-PerRACH-Occasion=1). Specifically, it is assumed that: there are 8 SSBs indexed as SSB #0 to SSB #7, and there is one RO in the frequency domain (e.g., msg 1-FDM=1). The 8 SSBs may be mapped or associated to 8 ROs (e.g., indexed as RO #0 to RO #7), respectively.

FIG. 4B shows a 2-to-1 association between SSBs and ROs (e.g., SSB-PerRACH-Occasion=2). Specifically, it is assumed that: there are 8 SSBs indexed as SSB #0 to SSB #7, and there is one RO in the frequency domain (e.g., msg1-FDM=1). The 8 SSBs may be mapped or associated to 8 ROs (e.g., indexed as RO #0 to RO #7). In particular, SSB #0 and SSB #1 may be associated with RO #0, SSB #2 and SSB #3 may be associated with RO #1, SSB #4 and SSB #5 may be associated with RO #2, SSB #6 and SSB #7 may be associated with RO #3, SSB #0 and SSB #1 may be associated with RO #4, SSB #2 and SSB #3 may be associated with RO #5, SSB #4 and SSB #5 may be associated with RO #6, and SSB #6 and SSB #7 may be associated with RO #7.

FIG. 4C shows a 1-to-2 association between SSBs and ROs (e.g., SSB-PerRACH-Occasion=1/2). Specifically, it is assumed that: there are 8 SSBs indexed as SSB #0 to SSB #7, and there are two ROs in the frequency domain (e.g., msg1-FDM=2). The 8 SSBs may be mapped or associated to 16 ROs (e.g., indexed as RO #0 to RO #15). In particular, SSB #0 may be associated with RO #0 and RO #1, SSB #1 may be associated with RO #2 and RO #3, SSB #2 may be associated with RO #4 and RO #5, SSB #3 may be associated with RO #6 and RO #7, SSB #4 may be associated with RO #8 and RO #9, SSB #5 may be associated with RO #10 and RO #11, SSB #6 may be associated with RO #12 and RO #13, and SSB #7 may be associated with RO #14 and RO #15.

NR supports preamble transmission without repetition. However, in some cases, the PRACH may be a bottlenecked channel which has the worst coverage performance, e.g., if a short PRACH format (e.g., PRACH format B4 as specified in TS 38.211) is used. Given this, how to improve the coverage of the PRACH needs to be addressed. It should be noted that the proposed solutions for PRACH coverage improvement are not dependent on PRACH formats.

According to some embodiments of the present application, the PRACH coverage enhancement may be obtained by PRACH repetitions transmitted in ROS associated with a same SSB (or a same beam). Specifically, the PRACH repetitions may refer to repeated PRACH preamble transmissions or transmitting the preamble in more than one RO.

In order to implement PRACH repetitions, one issue that needs to be solved is how to determine the ROs for PRACH repetition. The following factors need to be considered for determination of the ROs for PRACH repetition.

On one hand, the BS may configure FDMed ROs for PRACH repetition. However, PRACH repetitions may not be transmitted in the FDMed ROs in the same time instance, otherwise there will be no performance gain due to transmission power division between the FDMed ROs.

On the other hand, it is beneficial that the PRACH repetitions are transmitted in the time consecutive ROs (associated with a same SSB), such that the PRACH transmission latency may be reduced and PRACH reception operation in the BS side may be simplified. However, it can be seen that the SSB to RO associations illustrated in FIGS. 4A-4C may not support PRACH repetitions in time consecutive ROs associated with a same SSB. In the present disclosure, “time consecutive ROs” may include both consecutive ROs in the time domain and ROs in logically consecutive PRACH slots which are not consecutive in the time domain. For example, in the example illustrated in FIG. 3, an RO in the second half of the PRACH slot in subframe #0 and an RO in the first half of the PRACH slot in subframe #6 are also deemed to be time consecutive.

Besides, the BS and the UE need to have a common understanding on the ROS for PRACH repetition, otherwise the preamble cannot be correctly received by the BS.

Given the above, embodiments of the present application propose solutions for PRACH repetition. For example, embodiments of the present application propose solutions on SSB to RO association for PRACH repetition, such that the PRACH repetitions may be transmitted in time consecutive ROs but not FDMed ROs, and these ROs are associated with the same SSB. More details on embodiments of the present application will be described in the following text in combination with the appended drawings.

FIG. 5 is a flow chart illustrating an exemplary method for PRACH repetition according to some embodiments of the present application. The method in FIG. 5 may be implemented by a UE (e.g., UE 101a or UE 101b as shown in FIG. 1).

In the exemplary method shown in FIG. 5, in operation 501, the UE may receive configuration information indicating at least one SSB from a BS (e.g., BS 102 as shown in FIG. 1).

In operation 503, the UE may receive configuration information configuring a plurality of ROs from the BS. In some embodiments, the plurality of ROs may be separately configured for PRACH repetition, and are different from the ROs for PRACH without repetition.

In some embodiments, the configuration information indicating at least one SSB and the configuration information configuring a plurality of ROs may be included in a same signaling (e.g., a system information block (SIB) signaling). In some other embodiments, the above two kinds of configuration information may be included in different signalings.

In operation 505, the UE may associate (or map) a group of SSBs of the at least one SSB with (or to) a set of ROs of the plurality of ROs according to an association configuration (or a mapping configuration) and based at least in part on a PRACH repetition number (e.g., denoted as N1). The group of SSBs may include one or more SSBs. In other words, in operation 505, for N1, the UE may determine an SSB to RO association between a group of SSBs and a set of ROs according to an association configuration. In some embodiments, an SSB of the group of SSBs may be associated with a set of time consecutive ROs.

Based on the determined SSB to RO association, the UE may determine RO(s) to transmit PRACH repetitions. For example, the UE may determine an SSB from the at least one SSB for transmitting PRACH repetitions, wherein the group of SSBs includes the determined SSB. For example, the SSB may be an SSB have a good channel quality. Then, the UE may determine one or more ROs associated with the determined SSB for transmitting the PRACH repetitions based on the determined SSB to RO association, and transmit the PRACH repetitions in the determined one or more ROs.

The one or more ROs for transmitting the PRACH repetitions may also be determined based on a PRACH repetition number (e.g., denoted as N2) for PRACH repetition. N2 may be the same as or different from N1.

In some embodiments, to support PRACH repetition, the UE may receive configuration information configuring at least one PRACH repetition number (also referred to as PRACH repetition level) from the BS.

In some examples, the configuration information may configure one PRACH repetition number to the UE. Then, once the UE determines to perform PRACH repetition, the UE may determine the configured PRACH repetition number to be N2, and transmit N2 PRACH repetitions in N2 ROs associated with an SSB determined by the UE. For example, the configuration information may configure that the PRACH repetition number as {2}; once the UE determines to perform PRACH repetition, the UE may transmit 2 PRACH repetitions in 2 ROs associated with an SSB determined by the UE.

In some examples, the configuration information may configure more than one PRACH repetition number to the UE. Then, once the UE determines to perform PRACH repetition, the UE may determine or select one PRACH repetition number from the more than one PRACH repetition number to be N2, and transmit N2 PRACH repetitions in N2 ROs associated with an SSB determined by the UE. For example, the configuration information may configure that the PRACH repetition numbers as {2, 4}; once the UE determines to perform PRACH repetition, the UE may select either 2 or 4, and transmit either 2 PRACH repetitions in 2 ROs associated with an SSB determined by the UE or 4 PRACH repetitions in 4 ROs associated with an SSB determined by the UE. The selection may be based on the measured channel quality.

The following embodiments provide several solutions on how to associate a group of SSBs to a set of ROs in operation 505.

In some embodiments, the association configuration may indicate the association between SSBs and ROs. For example, the association configuration may include the parameter SSB-PerRACH-Occasion as stated above.

N1 may be one of the at least one PRACH repetition number configured by the BS or may be any other PRACH repetition number. The following embodiments provide several methods for obtaining N1 by the UE.

In some embodiments, the UE may determine N1 from the at least one PRACH repetition number configured by the BS. In such embodiments, N1 may be the same as N2.

As an example, only one PRACH repetition number is configured to the UE, and the UE may determine the configured PRACH repetition number to be N1. Then, in operation 505, the UE may determine the SSB to RO association for the configured PRACH repetition number. As another example, more than one PRACH repetition number may be configured to the UE, and the UE may determine one PRACH repetition number from the more than one PRACH repetition number to be N1.

In some embodiments, the UE may receive configuration information indicating N1 from the BS. For example, N1 may be determined by the BS based on a prior knowledge that most UEs will use a PRACH repetition number less than or equal to N1. In some cases, NI may be one of the at least one PRACH repetition number configured by the BS. In such cases, the configuration information configuring the at least one PRACH repetition number may also indicate which PRACH repetition number is N1. In some other cases, N1 may be a PRACH repetition number different from the at least one PRACH repetition number configured by the BS.

In some embodiments, N1 may be pre-defined for the UE. In some cases, N1 may be one of the at least one PRACH repetition number configured by the BS. For example, N1 may be the smallest value of the configured at least one PRACH repetition number or the highest value of the configured at least one PRACH repetition number. In some other cases, N1 may be a PRACH repetition number different from the at least one PRACH repetition number configured by the BS.

In operation 505, the UE may determine an SSB to RO association for N1. The SSB to RO association determined in operation 505 is designed such that the number of time consecutive ROs associated with the same SSB is no less than N1. Then, if N2 determined by the UE for PRACH repetition is equal to or less than N1, the PRACH repetitions may be transmitted in time consecutive ROs; otherwise, the PRACH repetitions may be transmitted in “segment” consecutive ROs.

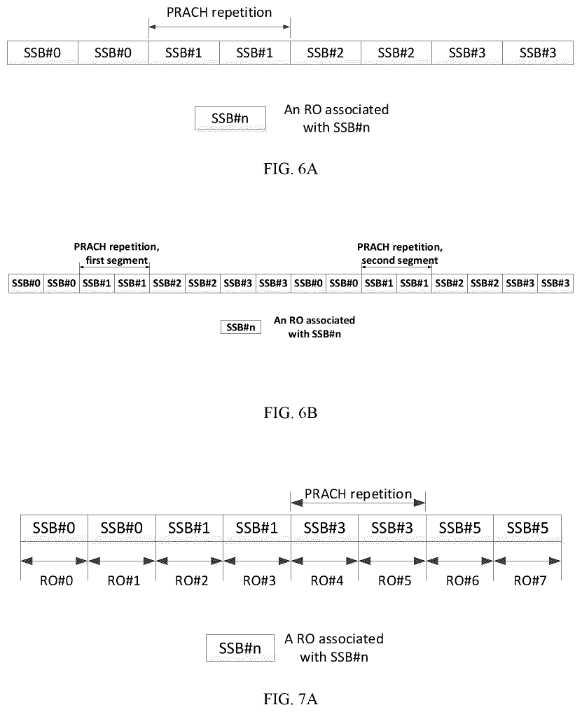

FIGS. 6A and 6B illustrate two exemplary associations between SSBs and ROs according to some embodiments of the present application.

In FIGS. 6A and 6B, it is assumed that N1 is 2, which means that the SSB to RO association determined in operation 505 may be designed such that the number of time consecutive ROs associated with a same SSB is no less than 2.

Referring to FIG. 6A, it is assumed that in operation 505, the UE associates 4 SSBs (e.g., SSB #0, SSB #1, SSB #2, and SSB #3) to 8 ROs. The SSB to RO association determined in operation 505 is shown in FIG. 6A. Assuming that the PRACH repetition number determined by the UE for PRACH repetition, i.e., N2, is 2 and the SSB determined by the UE for transmitting the PRACH repetitions is SSB #1, the UE may transmit the PRACH repetitions in 2 time consecutive ROs associated with SSB #1 as shown in FIG. 6A.

Referring to FIG. 6B, it is assumed that in operation 505, the UE associates 4SSBs (e.g., SSB #0, SSB #1, SSB #2, and SSB #3) to 16 ROs. The SSB to RO association determined in operation 505 is shown in FIG. 6B. Assuming that the PRACH repetition number determined by the UE for PRACH repetition, i.e., N2, is 4 and the SSB determined by the UE for transmitting the PRACH repetitions is SSB #1, the UE may transmit the PRACH repetitions in 2 segments, wherein each segment includes 2 time consecutive ROs as shown in FIG. 6B.

In some embodiments, the UE may determine the number of FDMed ROs for the PRACH repetition based on configuration information (e.g., denoted as msg1-FDM). The configuration information may indicate the number of FDMed ROs and be received from the BS.

In some cases, there are no FDMed ROs for PRACH repetition (e.g., msg1-FDM=1). In such cases, the group of SSBs associated to a set of ROs in operation 505 may consist of all the at least one SSB.

As an example, the number of time consecutive ROs associated with an SSB (e.g., denoted as 1/SSB-perRach-Occasion) determined based on the association configuration is equal to or larger than N1, and the group of SSBs is associated to the set of ROs by following a first association mechanism. The first association mechanism includes that the group of SSBs is associated to the set of ROs in an increasing order of time resource indexes of ROs, i.e., in an increasing order of time resource indexes for time multiplexed ROs within a PRACH slot, and then in an increasing order of indexes for PRACH slots.

As another example, the number of time consecutive ROs associated with an SSB (e.g., denoted as 1/SSB-perRach-Occasion) determined based on the association configuration is less than N1, and the group of SSBs is associated to the set of ROs by following a second association mechanism. The second association mechanism includes that: the group of SSBs is associated to the set of ROs in an increasing order of time resource indexes of ROs; and the association is based on N1. In some embodiments, for each RO, an association between SSB(s) and the RO is extended to N ROs, wherein N is a positive integer.

In some embodiments, N may be determined as follows:
In the case that the number of SSBs associated with an RO (e.g., denoted as SSB-perRach-Occasion) determined based on the association configuration is larger than or equal to 1, N is equal to N1; or
In the case that the number of SSBs associated with an RO (e.g., denoted as SSB-perRach-Occasion) determined based on the association configuration is less than 1, N is equal to N1 multiplied by the number of SSBs associated with an RO.

For example, if 1/SSB-perRach-Occasion>=N1, which means that the number of time consecutive ROs associated with a same SSB is equal to or larger than N1, the SSB to RO association for PRACH repetitions is performed based on the first association mechanism.

As another example, if 1/SSB-perRach-Occasion<N1, which means that the number of time consecutive ROs associated with a same SSB under the legacy SSB to RO association is less than N1. To ensure the number of time consecutive ROS associated with the same SSB is equal to N1, the SSB to RO association is based on the second association mechanism, wherein N may be determined as follows.
If SSB-PerRach-Occasion>=1, which means one RO is associated with one or more SSBs, N=N1.
If SSB-PerRach-Occasion<1, which means one SSB is associated with more than 1 RO, N=N1*SSB-PerRach-Occasion.

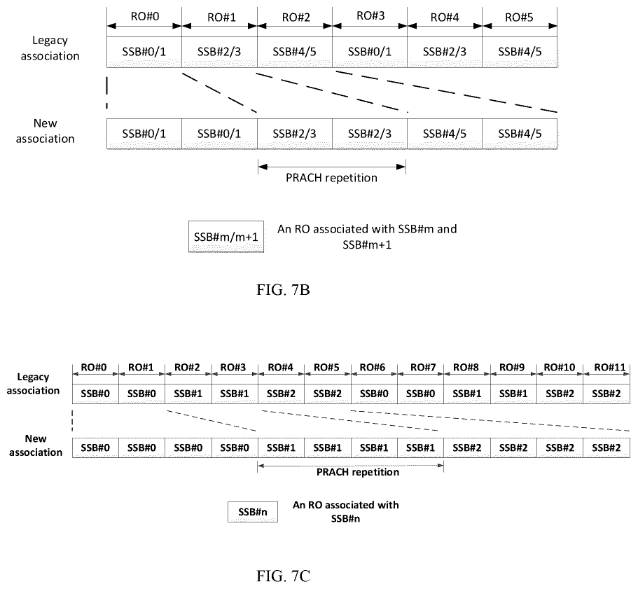

FIGS. 7A-7C illustrate three exemplary associations between SSBs and ROs according to some embodiments of the present application. In FIGS. 7A-7C, there are no FDMed ROs for PRACH repetition (e.g., msg1-FDM=1).

Referring to FIG. 7A, it is assumed that: the at least one SSB configured by the BS is SSB #0, SSB #1, SSB #3, and SSB #5; the plurality of ROs configured by the BS includes 8 ROs (e.g., denoted as RO #0-RO #7) in an SSB to RO association period; SSB-perRach-Occasion=1/2, i.e., one SSB is associated with two ROs; and N1=2.

In the example of FIG. 7A, since 1/SSB-perRach-Occasion=N1, the first association mechanism may be used in operation 505. That is, SSB #0, SSB #1, SSB #3, and SSB #5 are associated to the 8 ROs in the increasing order of the time resource indexes of ROS, and each SSB is associated with 2 ROs. The association between SSBs and ROs is shown in FIG. 7A. Assuming that the beam corresponding to SSB #3 is determined by the UE for PRACH repetition, then the UE may transmit PRACH repetitions in the two time consecutive ROs associated with SSB #3 (e.g., RO #4 and RO #5), as shown in FIG. 7A.

Referring to FIG. 7B, it is assumed that: the at least one SSB configured by the BS is SSB #0, SSB #1, SSB #2, SSB #3, SSB #4, and SSB #5; the plurality of ROs configured by the BS includes 6 ROs (e.g., denoted as RO #0-RO #5) in an SSB to RO association period; SSB-perRach-Occasion=2, i.e., two SSBs are associated with one RO; and N1=2.

In the example of FIG. 7B, since 1/SSB-perRach-Occasion<N1, the second association mechanism may be used in operation 505. That is, SSB #0, SSB #1, SSB #2, SSB #3, SSB #4, and SSB #5 are first associated to the 6 ROs in the increasing order of the time resource indexes of ROs, i.e., SSB #0 and SSB #1 are associated to RO #0, SSB #2 and SSB #3 are associated to RO #1, SSB #4 and SSB #5 are associated to RO #2, SSB #0 and SSB #1 are associated to RO #3, SSB #2 and SSB #3 are associated to RO #4, and SSB #4 and SSB #5 are associated to RO #5. Such association is defined as “legacy association” in FIG. 7B. Then, for each RO, an association between SSB(s) and the RO is extended to N ROs. Since SSB-perRach-Occasion>1, N=N1=2. That is, the association between SSB #0 and SSB #1 and RO #0 may be extended to RO #0 and RO #1, the association between SSB #2 and SSB #3 and RO #1 may be extended to RO #2 and RO #3, and the association between SSB #4 and SSB #5 and RO #3 may be extended to RO #4 and RO #5. Such association is defined as “new association” in FIG. 7B.

Assuming that the beam corresponding to SSB #3 is determined by the UE for PRACH repetition, then the UE may transmit PRACH repetitions in the two time consecutive ROs associated with SSB #3 (e.g., RO #2 and RO #3), as shown in FIG. 7B.

Referring to FIG. 7C, it is assumed that: the at least one SSB configured by the BS is SSB #0, SSB #1, and SSB #2; the plurality of ROs configured by the BS includes 12 ROs (e.g., denoted as RO #0-RO #11) in an SSB to RO association period; SSB-PerRach-Occasion=1/2, i.e., one SSB is associated with two ROs; and N1=4.

In the example of FIG. 7C, since 1/SSB-perRach-Occasion<N1, the second association mechanism may be used in operation 505. That is, SSB #0, SSB #1, and SSB #2 are first associated to the 12 ROs in the increasing order of the time resource indexes of ROs, i.e., SSB #0 are associated to RO #0 and RO #1, SSB #1 are associated to RO #2 and RO #3, SSB #2 are associated to RO #4 and RO #5, SSB #0 are associated to RO #6 and RO #7, SSB #1 are associated to RO #8 and RO #9, and SSB #3 are associated to RO #10 and RO #11. Such association is defined as “legacy association” in FIG. 7C. Then, for each RO, an association between SSB(s) and the RO is extended to N ROS. Since SSB-perRach-Occasion<1, N=N1* SSB-PerRach-Occasion=4*1/2=2. That is, the association between SSB #0 and RO #0-RO #1 may be extended to RO #0-RO #3, the association between SSB #1 and RO #2-RO #3 may be extended to RO #4-RO #7, the association between SSB #2 and RO #4-RO #5 may be extended to RO #8-RO #11. Such association is defined as “new association” in FIG. 7C.

Assuming that the beam corresponding to SSB #1 is determined by the UE for PRACH repetition, then the UE may transmit PRACH repetitions in the four consecutive ROs associated with SSB #1 (e.g., RO #4-RO #7), as shown in FIG. 7C.

In some other cases, there are FDMed ROs for the PRACH repetition (e.g., msg1-FDM is larger than 1). In such cases, the UE may divide the at least one SSB into at least one group of SSBs, wherein the number of groups of SSBs is equal to the number of FDMed ROs (e.g., msg1-FDM). The following options may be used for dividing the at least one SSB into at least one group of SSBs.

As an option, the SSBs are divided such that all of the at least one group of SSBs contain the same number of consecutive SSBs.

For example, a group of SSBs with index i may contain SSBs with indexes i*ceil(N_SSB/K)~(i+1)*ceil(N_SSB/K)−1, wherein N_SSB is the number of the at least one SSB, and K is the number of groups of SSBs.

For example, it is assumed that N_SSB=8, K=2, then the group of SSBs with index 0 may contain SSBs with indexes 0~3 in the 8 SSBs, and the group of SSBs with index 1 may contain the SSBs with indexes 4~7 in the 8 SSBs. Here the index of an SSB is a relative index of the SSB in the configured at least one SSB. For example, assuming that the at least one SSB contains {SSB #n₀, SSB #n₁, SSB #n₂, . . . , SSB #n_{N_SSB-1}}, then the relative indexes of the SSBs are {0, 1, 2, 3, . . . , N_SSB-1}.

In some cases, N_SSB cannot be divided by K, and then the first K−1 groups of SSBs may contain the same number of SSBs and the last group of SSBs may contain less SSBs.

As another option, the SSBs are divided such that a group of SSBs with an index i includes SSBs with indexes i+n*K in the at least one SSB, wherein 0≤i≤K−1, n=0, 1, 2 . . . N, K is the number of groups of SSBs, and i+N*K is less than or equal to a maximum index of the at least one SSB.

For example, it is assumed that N_SSB=8, K=2, then the group of SSBs with index 0 may contain SSBs with indexes {0,2,4,6} in the 8 SSBs, and the group of SSBs with index 1 may contain the SSBs with indexes {1,3,5,7} in the 8 SSBs. The index of an SSB is a relative index as stated above.

As yet another option, the SSBs are divided such that a group of SSBs of the at least one group of SSBs includes SSB(s) associated with the same PRACH repetition number. This option may be used for the case that different SSBs are configured with different PRACH repetition numbers.

For example, the first group of SSBs (e.g., a group of SSBs with group index 0) may include SSBs with the smallest PRACH repetition number. The second group of SSBs (e.g., a group of SSBs with group index 1) may include SSBs with a next level PRACH repetition number, and so on.

As yet another option, a group of SSBs of the at least one group of SSBs includes SSB(s) mapped to RO(s) locating in the same frequency domain position.

As yet another option, SSB(s) in each group of SSBs of the at least one group of SSBs may be configured by a BS.

In some embodiments, SSB(s) in each group of SSBs may be associated to a corresponding set of ROs locating in the same frequency domain position. In some cases, different groups of SSBs are associated with corresponding sets of ROS locating in different frequency domain positions.

In some embodiments, the association of SSB groups with corresponding sets of ROs are performed in an increasing order of frequency domain positions of the sets of ROS. For example, the SSB group with index 0 may be associated with a corresponding set of ROs in the lowest frequency domain position, the SSB group with index 1 may be associated with a corresponding set of ROs in a higher frequency domain position, and so on.

In some embodiments, the UE may divide the plurality of ROs into at least one RO group. Each RO group may include a corresponding set of ROs locating in the same frequency domain position.

For example, the indexing of RO group may be according to increasing order of frequency resource indexes of ROs. That is, the first RO group (e.g., RO group with index 0) may include ROs in the lowest frequency position, the second RO group (e.g., RO group with index 1) may include ROs in a higher frequency position, . . . , and the last RO group may include the ROs in the highest frequency position. As a result, there will be K RO groups, wherein K is equal to the number of FDMed ROs for the PRACH repetition (e.g., msg1-FDM), which is the same with the number of groups of SSBs.

In such embodiments, a group of SSBs of the at least one group of SSBs may be associated to a corresponding RO group of the at least one RO group.

For example, a group of SSBs with index i may be associated to an RO group with index m, wherein 0≤i<K−1, and 0≤m<K−1. In some cases, m=i, that is, a group of SSBs with index i may be associated to an RO group with index i.

For any group of SSBs in the K group of SSBs, the SSB to RO association between the SSBs in the group and the ROs in the corresponding RO group may follow the mechanism designed for the case of no FDMed ROs for PRACH repetition (e.g., msg1-FDM=1).

For example, the UE may determine an SSB from the at least one SSB for PRACH repetition. For example, the determined SSB may be an SSB have a good channel quality. Based on the above grouping solution, the UE may determine a group of SSBs which includes the determined SSB. SSB(s) in the group of SSBs may be associated to a set of ROs locating in the same frequency domain position. The UE may follow the mechanism designed for the case of no FDMed ROs for PRACH repetition (e.g., msg1-FDM=1) to perform SSB to RO association for the group of SSBs and the set of ROs.

As an example, the number of time consecutive ROs associated with an SSB (e.g., denoted as 1/SSB-perRach-Occasion) determined based on the association configuration is equal to or larger than N1, and the group of SSBs is associated to the set of ROs by following a first association mechanism. The first association mechanism includes that the group of SSBs is associated to the set of ROs in an increasing order of time resource indexes of ROs.

As another example, the number of time consecutive ROs associated with an SSB (e.g., denoted as 1/SSB-perRach-Occasion) determined based on the association configuration is less than N1, and the group of SSBs is associated to the set of ROs by following a second association mechanism. The second association mechanism includes that: the group of SSBs is associated to the set of ROs in an increasing order of time resource indexes of ROs; and the association is based on N1. In some embodiments, for each RO, an association between SSB(s) and the RO is extended to N ROs, wherein N is a positive integer.

In some embodiments, N may be determined as follows.
In the case that the number of SSBs associated with an RO (e.g., denoted as SSB-perRach-Occasion) determined based on the association configuration is larger than or equal to 1, N is equal to N1; or
In the case that the number of SSBs associated with an RO (e.g., denoted as SSB-perRach-Occasion) determined based on the association configuration is less than 1, N is equal to N1 multiplied by the number of SSBs associated with an RO.

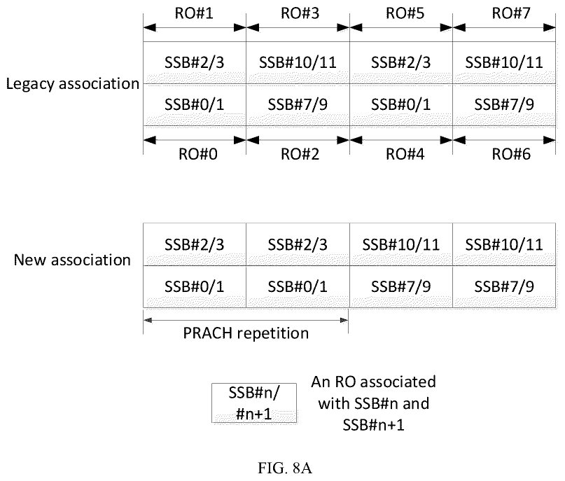

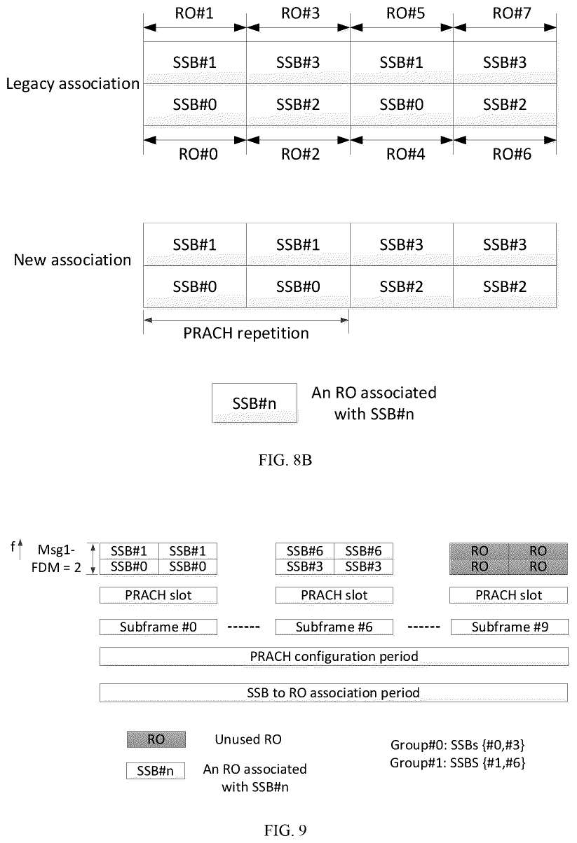

FIGS. 8A and 8B illustrate two exemplary associations between SSBs and ROs according to some embodiments of the present application. In FIGS. 8A-8B, there are 2 FDMed ROs for the PRACH repetition (e.g., msg1-FDM=2).

Referring to FIG. 8A, it is assumed that: the at least one SSB configured by the BS is SSBs {#0, #1, #2, #3, #7, #9, #10, #11}; the plurality of ROs configured by the BS includes 8 ROs (e.g., denoted as RO #0-RO #7) in an SSB to RO association period; SSB-perRach-Occasion=2, i.e., two SSBs are associated with one RO; and N1=2.

In the legacy association in FIG. 8A, SSBs #0 and #1 are associated to RO #0, SSBs #2 and #3 are associated to RO #1, SSBs #7 and #9 are associated to RO #2, SSBs #10 and #11 are associated to RO #3, SSBs #0 and #1 are associated to RO #4, SSBs #2 and #3 are associated to RO #5, SSBs #7 and #9 are associated to RO #6, and SSBs #10 and #11 are associated to RO #7.

In the new association in FIG. 8B (e.g., the association method provided by the embodiments of the subject application), since there are 2 FDMed ROs for the PRACH repetition (e.g., msg1-FDM=2), 8 SSBs are divided into two groups of SSBs, wherein group #0 may include 4 SSBs {#0, #1, #7, #9}, and group #1 may include 4 SSBs {#2, #3, #10, #11}. The SSBs in group #0 are associated with the ROs occupying the lowest frequency position, and the SSBs in group #1 are associated with ROs occupying the highest frequency position. For each SSB group, the association mechanism proposed for the case of no FDMed ROs configured for PRACH repetition (e.g., msg1-FDM=1) is reused.

Taking group #0 as an example, since 1/SSB-perRach-Occasion<N 1, the second association mechanism may be used in operation 505. That is, SSBs {#0, #1, #7, #9} are first associated to ROs {#0, #2, #4, #6} in the increasing order of the time resource indexes of ROs, i.e., SSBs #0 and #1 are associated to RO #0, SSBs #7 and #9 are associated to RO #2, SSBs #0 and #1 are associated to RO #4, and SSBs #7 and #9 are associated to RO #6. Then, for each RO, an association between SSB(s) and the RO is extended to N ROs. Since SSB-perRach-Occasion>1, N=N1=2. That is, the association between SSBs #0 and #1 and RO #0 may be extended to RO #0 and RO #2, and the association between SSBs #7 and #9 and RO #1 may be extended to RO #4 and RO #6. Such association is defined as “new association” in FIG. 8A.

For group #1, the second association mechanism may also be used in operation 505. That is, SSBs #2 and #3 may be associated to RO #1 and RO #3, and SSBs #10 and #11 may be associated to RO #5 and RO #7.

Assuming that the beam corresponding to SSB #1 is determined by the UE for PRACH repetition, then the UE may transmit PRACH repetitions in the two time consecutive ROs associated with SSB #1 (e.g., RO #0 and RO #2), as shown in FIG. 8A.

Referring to FIG. 8B, it is assumed that: the at least one SSB configured by the BS is SSBs {#0, #1, #2, #3}; the plurality of ROs configured by the BS includes 8 ROS (e.g., denoted as RO #0-RO #7) in an SSB to RO association period; SSB-perRach-Occasion=1, i.e., one SSB is associated with one RO; and N1=2.

In the legacy association in FIG. 8B, SSB #0 is associated to RO #0, SSB #1 is associated to RO #1, SSB #2 is associated to RO #2, SSB #3 is associated to RO #3, SSB #0 is associated to RO #4, SSB #1 is associated to RO #5, SSB #2 is associated to RO #6, and SSB #3 is associated to RO #7.

In the new association in FIG. 8B (e.g., the association method provided by the embodiments of the subject application), since there are 2 FDMed ROs for the PRACH repetition (e.g., msg1-FDM=2), 8 SSBs are divided into two groups of SSBs, wherein group #0 may include 2 SSBs {#0, #2}, and group #1 may include 2 SSBs {#1, #3}. The SSBs in group #0 are associated with the ROs occupying the lowest frequency position, and the SSBs in group #1 are associated with ROs occupying the highest frequency position. For each SSB group, the association mechanism proposed for the case of no FDMed ROs configured for PRACH repetition (e.g., msg1-FDM=1) is reused.

Taking group #0 as an example, since 1/SSB-perRach-Occasion<N 1, the second association mechanism may be used in operation 505. That is, SSBs {#0, #2} are first associated to ROs {#0, #2, #4, #6} in the increasing order of the time resource indexes of ROs, i.e., SSB #0 is associated to RO #0, SSB #2 is associated to RO #2, SSB #0 is associated to RO #4, and SSB #2 is associated to RO #6. Then, for each RO, an association between SSB(s) and the RO is extended to N ROs. Since SSB-perRach-Occasion=1, N=N1=2. That is, the association between SSB #0 and RO #0 may be extended to RO #0 and RO #2, and the association between SSB #2 and RO #2 may be extended to RO #4 and RO #6. Such association is defined as “new association” in FIG. 8B.

For group #1, the second association mechanism may also be used in operation 505. That is, SSB #1 may be associated to RO #1 and RO #3, and SSB #3 may be associated to RO #5 and RO #7.

Assuming that the beam corresponding to SSB #0 is determined by the UE for PRACH repetition, then the UE may transmit PRACH repetitions in the two time consecutive ROs associated with SSB #0 (e.g., RO #0 and RO #2), as shown in FIG. 8B.

In some embodiments, for the group of SSBs including the SSB for PRACH repetition, the UE may determine an SSB to RO association period for the group of SSBs.

In an embodiment, the SSB to RO association period may be X times of a PRACH configuration period, and includes at least one mapping cycle for SSB(s) in the group of SSBs, wherein X is a positive integer.

In another embodiment, the SSB to RO association period for the group of SSBs may also apply to any other group of the at least one group of SSBs. In such embodiments, the UE may determine an SSB to RO association period for all of the at least one group of SSBs. The SSB to RO association period may be X times of a PRACH configuration period and includes at least one mapping cycle for SSB(s) in a group of SSBs which includes the largest number of SSBs among the at least one group of SSBs.

FIG. 9 illustrates an exemplary method for determining an SSB to RO association period according to some embodiments of the present application. Referring to FIG. 9, a PRACH configuration period may include 10 subframes, among which subframe #0, subframe #6, and subframe #9 are configured to contain PRACH slots. A PRACH slot in this example contains 2 ROs in the time domain and 2 ROs (msg1-FDM=2) in the frequency domain.

In the example of FIG. 9, it is assumed that the at least one SSB configured by the BS is SSBs {#0, #1, #3, #6}, wherein SSB group #0 contains SSBs with indexes 0 and 2, i.e., SSBs {#0, #3}, and SSB group #1 contains SSBs with indexes 1 and 3, i.e., SSBs {#1, #6}. The association between SSBs and ROs are shown in FIG. 9.

In the example of FIG. 9, when the UE determines SSB #0 or SSB #3 for PRACH repetition, the UE may determine an SSB to RO association period for SSB group #0. For example, the UE may determine that the SSB to RO association period to be the PRACH configuration period, which contains one PRACH configuration period, and contains one mapping cycle for the SSBs in SSB group #0.

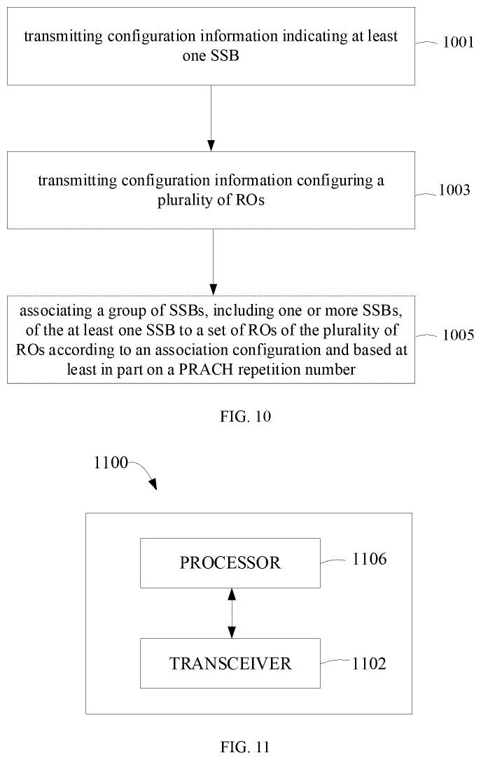

FIG. 10 is a flow chart illustrating another exemplary method for PRACH repetition according to some embodiments of the present application. The method in FIG. 10 may be implemented by a BS (e.g., BS 102 as shown in FIG. 1).

In the exemplary method shown in FIG. 10, in operation 1001, the BS may transmit configuration information indicating at least one SSB to one or more UEs (e.g., UE 101a and UE 101b as shown in FIG. 1).

In operation 1003, the BS may transmit configuration information configuring a plurality of ROs to one or more UEs. In some embodiments, the plurality of ROs may be separately configured for PRACH repetition, and are different from the ROs for PRACH without repetition.

In some embodiments, the configuration information indicating at least one SSB and the configuration information configuring a plurality of ROs may be included in a same signaling (e.g., a system information block (SIB) signaling). In some other embodiments, the above two kinds of configuration information may be included in different signalings.

In operation 1005, the BS may associate (or map) a group of SSBs of the at least one SSB to (or with) a set of ROs of the plurality of ROs according to an association configuration (or a mapping configuration) and based at least in part on a PRACH repetition number (e.g., denoted as N1). The group of SSBs may include one or more SSBs. In other words, in operation 1005, for N1, the BS may determine an SSB to RO association between a group of SSBs and a set of ROs according to an association configuration. In some embodiments, an SSB of the group of SSBs may be associated with a set of time consecutive ROs.

In some embodiments, the association configuration may indicate the association between SSBs and ROs. For example, the association configuration may include the parameter SSB-PerRACH-Occasion as stated above.

In some embodiments, to support PRACH repetition, the BS may transmit configuration information configuring at least one PRACH repetition number (also referred to as PRACH repetition level) to the one or more UEs. N1 may be one of the at least one PRACH repetition number configured by the BS or may be any other PRACH repetition number. The following embodiments provide several methods for determining N1 by the UE.

In some embodiments, the configuration information may configure one PRACH repetition number to the one or more UEs. Then, N1 may be the PRACH repetition number configured by the BS.

In some embodiments, the configuration information may configure more than one PRACH repetition number to the one or more UEs. In such embodiments, each UE itself may determine a PRACH repetition number from the more than one PRACH repetition number for PRACH repetition. Accordingly, in such embodiments, N1 may be any one PRACH repetition number in the more than one PRACH repetition number. In other words, for each PRACH repetition number in the more than one PRACH repetition number, the BS may perform operation 1005.

In some embodiments, the BS may transmit configuration information indicating N1 to the one or more UEs. For example, N1 may be determined by the BS based on a prior knowledge that most UEs will use a PRACH repetition number less than or equal to N1. In some cases, N1 may be one of the at least one PRACH repetition number configured by the BS. In such cases, the configuration information configuring the at least one PRACH repetition number may also indicate which PRACH repetition number is N1. In some other cases, N1 may be a PRACH repetition number different from the at least one PRACH repetition number configured by the BS.

In some embodiments, N1 may be pre-defined. In some cases, N1 may be one of the at least one PRACH repetition number configured by the BS. In some other cases, N1 may be a PRACH repetition number different from the at least one PRACH repetition number configured by the BS.

In operation 1005, the BS may determine SSB to RO association for N1. The SSB to RO association determined in operation 1005 is designed such that the number of time consecutive ROs associated with the same SSB is no less than N1. The BS may use the same methods as those used by the UE as described in any of the above embodiments to determine the SSB to RO association in operation 1005.

In some embodiments, the BS may transmit configuration information (e.g., denoted as msg1-FDM) indicating the number of FDMed ROs to the one or more UEs.

In some cases, there are no FDMed ROs for PRACH repetition (e.g., msg1-FDM=1). In such cases, the group of SSBs associated to a set of ROs in operation 1005 may consist of all the at least one SSB.

As an example, the number of time consecutive ROs associated with an SSB (e.g., denoted as 1/SSB-perRach-Occasion) determined based on the association configuration is equal to or larger than N1, and the group of SSBs is associated to the set of ROs by following a first association mechanism. The first association mechanism includes that the group of SSBs is associated to the set of ROs in an increasing order of time resource indexes of ROs.

As another example, the number of time consecutive ROs associated with an SSB (e.g., denoted as 1/SSB-perRach-Occasion) determined based on the association configuration is less than N1, and the group of SSBs is associated to the set of ROs by following a second association mechanism. The second association mechanism includes that: the group of SSBs is associated to the set of ROs in an increasing order of time resource indexes of ROs; and for each RO, an association between SSB(s) and the RO is extended to N ROs, wherein N is a positive integer.

In some embodiments, N may be determined as follows.
In the case that the number of SSBs associated with an RO(e.g., denoted as SSB-perRach-Occasion) determined based on the association configuration is larger than or equal to 1, N is equal to N 1; or
In the case that the number of SSBs associated with an RO (e.g., denoted as SSB-perRach-Occasion) determined based on the association configuration is less than 1, N is equal to N1 multiplied by the number of SSBs associated with an RO.

The examples for the first association mechanism and the second association mechanism may be the same as those illustrated in FIGS. 7A-7C.

In some other cases, there are FDMed ROs for PRACH repetition (e.g., msg 1-FDM is larger than 1). In such cases, the BS may divide the at least one SSB into at least one group of SSBs, wherein the number of groups of SSBs is equal to the number of FDMed ROs (e.g., msg1-FDM). The BS may use the same options as those used by the UE to divide the at least one SSB into at least one group of SSBs.

As an option, the SSBs are divided such that all of the at least one group of SSBs contain the same number of consecutive SSBs.

As another option, the SSBs are divided such that a group of SSBs with an index i includes SSBs with indexes i+n*K in the at least one SSB, wherein 0≤i≤K−1, n=0, 1, 2 . . . N, K is the number of groups of SSBs, and i+N*K is less than or equal to a maximum index of the at least one SSB.

As yet another option, the SSBs are divided such that a group of SSBs of the at least one group of SSBs includes SSB(s) associated with the same PRACH repetition number.

As yet another option, a group of SSBs of the at least one group of SSBs includes SSB(s) mapped to RO(s) locating in the same frequency domain position.

As yet another option, SSB(s) in each group of SSBs of the at least one group of SSBs may be configured by the BS.

In some embodiments, SSB(s) in each group of SSBs may be associated to a corresponding set of ROs locating in the same frequency domain position. In some cases, different groups of SSBs are associated with corresponding sets of ROs locating in different frequency domain positions.

In some embodiments, the BS may divide the plurality of ROs into at least one RO group. Each RO group may include a corresponding set of ROs locating in the same frequency domain position. The indexing of RO group determined by the UE may also apply here. In such embodiments, the number of RO groups in the at least one RO group is equal to the number of FDMed ROs for PRACH repetition (e.g., msg1-FDM), which is the same as the number of groups of SSBs. A group of SSBs of the at least one group of SSBs may be associated to a corresponding RO group of the at least one RO group.

For example, a group of SSBs with index i may be associated to an RO group with index m, wherein 0≤i<K−1, and 0≤m<K−1. In some cases, m=i, that is, a group of SSBs with index i may be associated to an RO group with index i.

For each group of SSBs in the K group of SSBs, the BS may perform operation 1005. For simplify, taking a group of SSBs in the K group of SSBs as an example to illustrate operation 1005, SSB(s) in the group of SSBs may be associated to a set of ROs locating in the same frequency domain position. The BS may follow the mechanism designed for no FDMed ROs configured for PRACH repetition (e.g., msg1-FDM=1) to perform SSB to RO association for the group of SSBs and the set of ROs.

As an example, the number of time consecutive ROs associated with an SSB (e.g., denoted as 1/SSB-perRach-Occasion) determined based on the association configuration is equal to or larger than N1, and the group of SSBs is associated to the set of ROs by following a first association mechanism. The first association mechanism includes that the group of SSBs is associated to the set of ROs in an increasing order of time resource indexes of ROs.

As another example, the number of time consecutive ROs associated with an SSB (e.g., denoted as 1/SSB-perRach-Occasion) determined based on the association configuration is less than N1, and the group of SSBs is associated to the set of ROs by following a second association mechanism. The second association mechanism includes that: the group of SSBs is associated to the set of ROs in an increasing order of time resource indexes of ROs; and for each RO, an association between SSB(s) and the RO is extended to N ROs, wherein N is a positive integer.

In some embodiments, N may be determined as follows.
In the case that the number of SSBs associated with an RO (e.g., denoted as SSB-perRach-Occasion) determined based on the association configuration is larger than or equal to 1, N is equal to N1; or
In the case that the number of SSBs associated with an RO (e.g., denoted as SSB-perRach-Occasion) determined based on the association configuration is less than 1, N is equal to N1 multiplied by the number of SSBs associated with an RO.

Examples for associating a group of SSBs and a set of ROs may also refer to FIGS. 8A and 8B.

In some embodiments, for each group of SSBs of the at least one group of SSBs, the BS may determine an SSB to RO association period for the corresponding group of SSBs. For example, the SSB to RO association period may be X times of a PRACH configuration period, and includes at least one mapping cycle for SSB(s) in the corresponding group of SSBs, wherein X is a positive integer.

In some other embodiments, the BS may determine an SSB to RO association period for all of the at least one group of SSBs. The SSB to RO association period may be X times of a PRACH configuration period and includes at least one mapping cycle for SSB(s) in a group of SSBs which includes the largest number of SSBs among the at least one group of SSBs.

An example for determining an SSB to RO association period may also refer to FIG. 9.

FIG. 11 illustrates a simplified block diagram of an exemplary apparatus 1100 for PRACH repetition according to some embodiments of the present application. In some embodiments, the apparatus 1100 may be or include at least part of a UE. In some other embodiments, the apparatus 1100 may be or include at least part of a BS.

Referring to FIG. 11, the apparatus 1100 may include at least one transceiver 1102 and at least one processor 1106. The at least one transceiver 1102 is coupled to the at least one processor 1106.

Although in this figure, elements such as the transceiver 1102 and the processor 1106 are illustrated in the singular, the plural is contemplated unless a limitation to the singular is explicitly stated. In some embodiments of the present application, the transceiver 1102 may be divided into two devices, such as receiving circuitry (or a receiver) and transmitting circuitry (or a transmitter). In some embodiments of the present application, the apparatus 1100 may further include an input device, a memory, and/or other components. The transceiver 1102 and the processor 1106 may be configured to perform any of the methods described herein (e.g., the methods described with respect to FIGS. 2-10 or other methods described in the embodiments of the present application).

According to some embodiments of the present application, the apparatus 1100 may be a UE, and the transceiver 1102 and the processor 1106 may be configured to perform operations of the UE in any of the methods as described with respect to FIGS. 2-9 or other methods described in the embodiments of the present application. For example, the processor 1106 is configured to cause the UE to: receive configuration information indicating at least one SSB; receive configuration information configuring a plurality of ROs; and associate a group of SSBs, including one or more SSBs, of the at least one SSB to a set of ROs of the plurality of ROS according to an association configuration and based at least in part on a PRACH repetition number.

According to some embodiments of the present application, the apparatus 1100 may be a BS, and the transceiver 1102 and the processor 1106 may be configured to perform operations of the BS in any of the methods as described with respect to FIGS. 2-4 and 6-10 or other methods described in the embodiments of the present application. For example, the processor 1106 is configured to cause the BS to: transmit configuration information indicating at least one SSB; transmit configuration information configuring a plurality of ROs; and associate a group of SSBs, including one or more SSBs, of the at least one SSB to a set of ROs of the plurality of ROs according to an association configuration and based at least in part on a PRACH repetition number.

In some embodiments of the present application, the apparatus 1100 may further include at least one non-transitory computer-readable medium. In some embodiments of the present disclosure, the non-transitory computer-readable medium may have stored thereon computer-executable instructions to cause the processor 1106 to implement any of the methods as described above. For example, the computer-executable instructions, when executed, may cause the processor 1106 to interact with the transceiver 1102, so as to perform operations of the methods, e.g., as described with respect to FIGS. 2-10 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for PRACH repetition, including a processor and a memory. Computer programmable instructions for implementing a method for PRACH repetition are stored in the memory, and the processor is configured to perform the computer programmable instructions to implement the method for PRACH repetition. The method for PRACH repetition may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for PRACH repetition according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
receive configuration information indicating at least one synchronization signal and physical broadcast channel (PBCH) block (SSB);
receive configuration information configuring a plurality of random access channel (RACH) occasions (ROs); and
associate a group of SSBs, including one or more SSBs, of the at least one SSB to a set of ROs of the plurality of ROs according to an association configuration and based at least in part on a physical random access channel (PRACH) repetition number.

2. The UE of claim 1, wherein the at least one processor is further configured to cause the UE to:
determine the PRACH repetition number from at least one PRACH repetition number, wherein the at least one PRACH repetition number is configured by configuration information; or
receive configuration information indicating the PRACH repetition number; or wherein the PRACH repetition number is pre-defined for the UE.

3. The UE of claim 1, wherein the plurality of ROs are separately configured for PRACH repetition.

4. The UE of claim 1, wherein an SSB of the group of SSBs is associated with a set of time consecutive ROs.

5. The UE of claim 1, wherein the at least one processor is further configured to cause the UE to:
receive configuration information indicating number of frequency domain multiplexed (FDMed) ROs in a frequency domain; and
divide the at least one SSB into at least one group of SSBs, wherein the number of groups of SSBs is equal to the number of FDMed ROs.

6. The UE of claim 5, wherein, when the number of FDMed ROs is equal to 1, the group of SSBs includes the at least one SSB.

7. The UE of claim 5, wherein:
all of the at least one group of SSBs contain the same number of consecutive SSBs;
a group of SSBs with an index i includes SSBs with indexes i+n*K in the at least one SSB, wherein 0≤i≤K−1, n=0, 1, 2 . . . N, K is the number of groups of SSBs, and i+N*K is less than or equal to a maximum index of the at least one SSB;
a group of SSBs of the at least one group of SSBs includes SSB(s) associated with the same PRACH repetition number;
a group of SSBs of the at least one group of SSBs includes SSBs mapped to ROs locating in the same frequency domain position; or
SSBs in each group of SSBs of the at least one group of SSBs are configured by a base station (BS).

8. The UE of claim 5, wherein SSBs in the group of SSBs are associated to a set of ROs locating in the same frequency domain position.

9. The UE of claim 5, wherein:
when the number of time consecutive ROs associated with an SSB determined based on the association configuration is equal to or larger than the PRACH repetition number, the group of SSBs is associated to the set of ROs by following a first association mechanism; or
when the number of time consecutive ROs associated with an SSB determined based on the association configuration is less than the PRACH repetition number, the group of SSBs is associated to the set of ROs by following a second association mechanism.

10. The UE of claim 5, wherein the at least one processor is further configured to cause the UE to: divide the plurality of ROs into at least one RO group, wherein the number of RO groups in the at least one RO group is equal to the number of groups of SSBs, wherein each RO group includes a corresponding set of ROs locating in the same frequency domain position, and wherein a group of SSBs of the at least one group of SSBs is associated to a corresponding RO group of the at least one RO group.

11. The UE of claim 9, wherein the second association mechanism associates the group of SSBs to the set of ROs in an increasing order of time resource indexes of ROs; and for each RO, an association between SSBs and the RO is extended to N ROs, wherein N is a positive integer.

12. The UE of claim 11, wherein:
when the number of SSBs associated with an RO determined based on the association configuration is larger than or equal to 1, N is equal to the PRACH repetition number; or
when the number of SSBs associated with an RO determined based on the association configuration is less than 1, N is equal to the PRACH repetition number multiplied by the number of SSBs associated with an RO.

13. The UE of claim 5, wherein the at least one processor is further configured to cause the UE to:
determine an SSB to RO association period for the group of SSBs, wherein the SSB to RO association period is X times of a PRACH configuration period and includes at least one mapping cycle for SSBs in the group of SSBs, wherein X is a positive integer.

14. A base station (BS) for wireless communication, comprising:
at least one memory; and
at least one processor coupled with the at least one memory and configured to cause the BS to:
transmit configuration information indicating at least one synchronization signal and physical broadcast channel (PBCH) block (SSB);
transmit configuration information configuring a plurality of random access channel (RACH) occasions (ROs); and
associate a group of SSBs, including one or more SSBs, of the at least one SSB to a set of ROs of the plurality of ROs according to an association configuration and based at least in part on a PRACH repetition number.

15. A method performed by a user equipment (UE), the method comprising:
receiving configuration information indicating at least one synchronization signal and physical broadcast channel (PBCH) block (SSB);
receiving configuration information configuring a plurality of random access channel (RACH) occasions (ROs); and
associating a group of SSBs, including one or more SSBs, of the at least one SSB to a set of ROs of the plurality of ROs according to an association configuration and based at least in part on a physical random access channel (PRACH) repetition number.

16. The method of claim 15, further comprising:
determining the PRACH repetition number from at least one PRACH repetition number, wherein the at least one PRACH repetition number is configured by configuration information; or
receiving configuration information indicating the PRACH repetition number; or wherein the PRACH repetition number is pre-defined for the UE.

17. The method of claim 15, wherein the plurality of ROs are separately configured for PRACH repetition.

18. The method of claim 15, wherein an SSB of the group of SSBs is associated with a set of time consecutive ROs.

19. The method of claim 15, further comprising:
receiving configuration information indicating a number of frequency domain multiplexed (FDMed) ROs in a frequency domain; and
dividing the at least one SSB into at least one group of SSBs, wherein the number of groups of SSBs is equal to the number of FDMed ROs.

20. A method performed by a base station (BS), the method comprising:
transmitting configuration information indicating at least one synchronization signal and physical broadcast channel (PBCH) block (SSB);
transmitting configuration information configuring a plurality of random access channel (RACH) occasions (ROs); and
associating a group of SSBs, including one or more SSBs, of the at least one SSB to a set of ROs of the plurality of ROs according to an association configuration and based at least in part on a PRACH repetition number.
